(19) United States
(12) Patent Application Publication
(10) Pub. No.: US 2008/0175656 A1
(43) Pub. Date: Jul. 24, 2008

(54) SNAP-FIT CONNECTION AND CONSTRUCTION SYSTEM

(75) Inventors: Axel Blattner, Stuttgart (DE); Hubert Mainka, Aalen (DE); Bernd Kugler, Schwabisch-Gmund (DE)

Correspondence Address: CANTOR COLBURN, LLP, 20 Church Street, 22nd Floor, Hartford, CT, 06103, US

(73) Assignee: Schleich GmbH, Schwabisch Gmund (DE)

(21) Appl. No.: 11/758,400

(22) Filed: Jun. 5, 2007

(30) Foreign Application Priority Data
Jun. 8, 2006 (DE) 20 2006 009 036.3

(51) Int. Cl. F16B 13/02

(52) U.S. Cl. 403/292

(57) ABSTRACT

Disclosed is a snap-fit connection for construction elements having a construction element, which is connectable to a base element by bringing a first snap-fit element of the construction element into engagement with a second snap-fit element of the base element, the second snap-fit element being located inside an aperture in the base element, characterized in that the first snap-fit element has a bulge-like projection with a bulge diameter and the second snap-fit element has a web-like or shoulder-like projection on at least one wall of the aperture.

The present invention relates to a snap-fit connection for construction elements for connecting a construction element to a base element according to the preamble of protective claim 1, a construction element suitable for this purpose according to protective claim 12, a base element suitable for this purpose according to protective claim 13 and a construction system composed of the corresponding elements according to protective claim 14.

Snap-fit connections of this type are known for example from EP 0 728 507 B1, which discloses a construction kit-type play system for erecting buildings, vehicle superstructures, landscapes etc., wherein a construction element of plastics material can be applied to a base element by means of a snap-fit plug-in connection. To make the connection, a connecting element is used, which has on one side supported pegs for detachable snap-fit connection to the construction element and on the other side groove-like projections for snap-fit connection to the base element. To form the snap-fit connection, apertures are provided in the base element having side walls, wherein on two opposing side walls, snap-fit recesses are formed. The pegs of the connecting element engage in the corresponding recesses of the side walls. In this case, recesses are formed on opposing side walls, which receive the bulge-like peg ends and ensure easy detachability of the connection. In the two other opposing side walls of the substantially rectangular recesses of the base element are undercuts, into which the groove-like snap-fit elements engage in order thus to produce a very firm connection which can only be undone with difficulty.

The object of the present invention is therefore to indicate a snap-fit connection for construction elements which not only permits rotation of the construction element relative to the base element, but also ensures a very secure connection between the elements without requiring particularly strenuous efforts for subsequently taking the elements apart. At the same time, the construction system is to be easy and advantageous to manufacture and have as few components as possible, i.e. in particular not have separate connecting elements for connecting the construction element to the base element.

The invention achieves these objects by the characterising features of the independent protective claims 1, 12, 13, and 14. Advantageous embodiments of the snap-fit connection will appear from subclaims 2 to 11.

According to the present invention, the snap-fit connection for construction elements has a first snap-fit element which is fixed to the construction element and which may be brought into engagement with a second snap-fit element of the base element. To this end, the first snap-fit element is inserted into an aperture in the base element in which the second snap-fit element is located. In this case, the first snap-fit element has a bulge-like projection with a specified bulge diameter, whilst the second snap-fit element has a web-like or shoulder-like projection on at least one wall of the aperture in the base element. The bulge-like projection of the first snap-fit element in this case comes into engagement with the web-like or shoulder-like projection of the second snap-fit element and is locked therewith.

The snap-fit distance between the at least one web-like or shoulder-like projection and the opposing wall inside the aperture is in particular smaller than or equal to the bulge diameter, so that an interference fit or snap-fit connection is then created when the bulge-like projection comes to rest behind the web-like or shoulder-like projection inside the aperture upon insertion. Advantageously, the second snap-fit element in this case has at least two web-like or shoulder-like projections on each wall of the aperture inside the base element.

According to a preferred embodiment, the at least two web-like or shoulder-like projections on mutually opposing walls of the aperture have snap-fit distances which are smaller than or equal to the bulge diameter of the bulge-like projection of the first snap-fit element, this snap-fit distance being measured between the at least two opposing web-like or shoulder-like projections. The web-like or shoulder-like projections in this case extend inside the aperture beyond a shoulder depth which is in particular smaller than the aperture depth of the aperture. The web-like or shoulder-like projection is in this case located on the side of the aperture associated with the construction element to be inserted, so that upon insertion of the first snap-fit element the bulge-like projection slides along the web-like or shoulder-like projection and upon reaching the shoulder depth comes to rest behind the projection.

According to a particularly preferred embodiment of the present invention, the aperture in the base element has 6 walls, in which case the web-like or shoulder-like projections of the second snap-fit element come to rest only on two opposing walls.

The bulge-like projection of the first snap-fit element extends preferably in a dome shape along a peg, which projects substantially at right-angles from the construction element. Preferably the peg and the construction element are integral, in particular manufactured from a flexible plastics material. The peg can in this case be formed with rotational symmetry with a cavity so that the peg wall, upon locating of the peg in the second snap-fit element, is displaced inwards, i.e. in the direction of the cavity, in order thus to permit the bulge-like projection to slide over the web-like or shoulder-like projection of the second snap-fit element. After complete insertion of the peg, the bulge-like projection comes to rest behind the web-like or shoulder-like projection, so that an undercut on the peg receives the web-like or shoulder-like projection of the second snap-fit element after locating, in which case the undercut is located on the exterior of the peg wall between the bulge-like projection of the first snap-fit element and the body of the construction element.

Furthermore, the present invention discloses a construction element with a peg which has a first snap-fit element consisting of a bulge-like projection with a bulge diameter and of an undercut, which is located on the exterior of the peg wall between the bulge-like projection and the body of the construction element. At the same time, the invention comprises a base element suitable for the purpose having the aperture, a second snap-fit element being mounted in the aperture and consisting of one but preferably two web-like or shoulder-like projections, which is mounted on at least one, but preferably two opposing walls of the aperture.

Finally, the invention discloses a construction system having a base element and a construction element, the construction element having the first snap-fit element and the base element the second snap-fit element, which upon locating produce the snap-fit connection according to the invention. The snap-fit distance between the web-like or shoulder-like projection and the opposing walls inside the aperture or between the opposing web-like or shoulder-like projections is in this case smaller than or equal to the bulge diameter, so that a non-positive connection is produced.

A particularly preferred embodiment of the present invention is explained more fully with the aid of the attached drawings, which show:

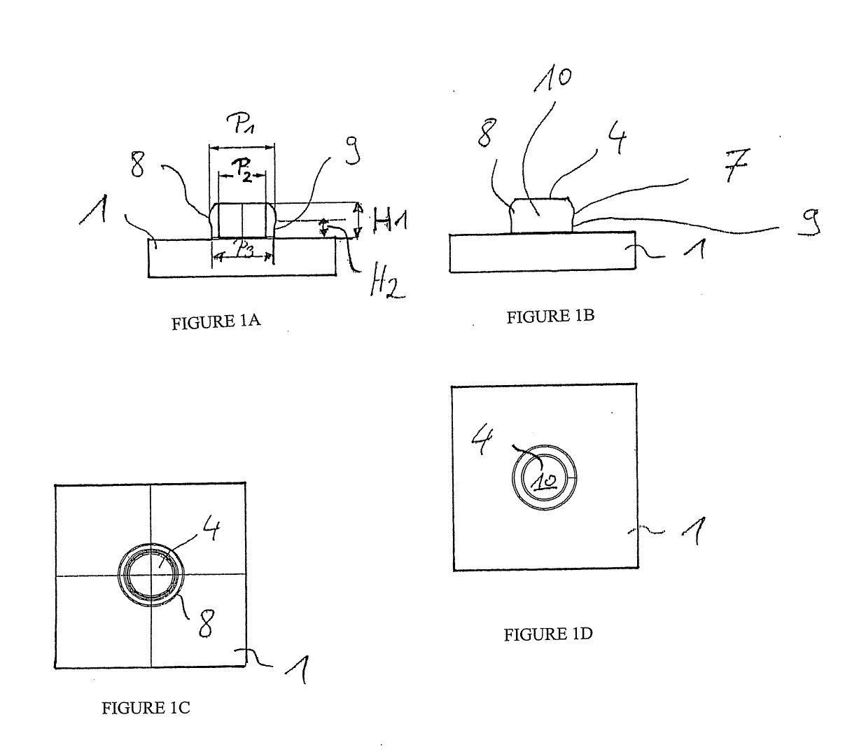

FIG. 1a-d: the cross-section, side view, plan view and underneath view of a construction element according to the invention having a first snap-fit element,

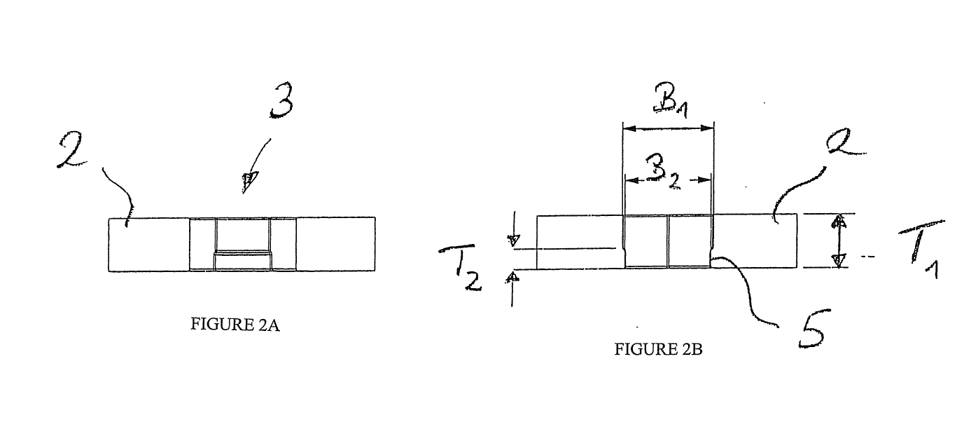

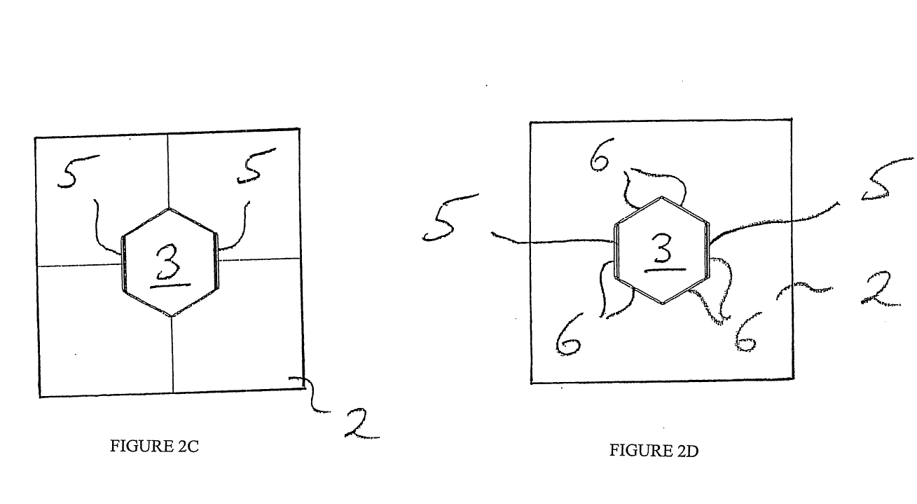

FIG. 2a-d: the cross-section, elevation view, plan view and underneath view of a base element according to the invention having an aperture and web-like or shoulder-like projection,

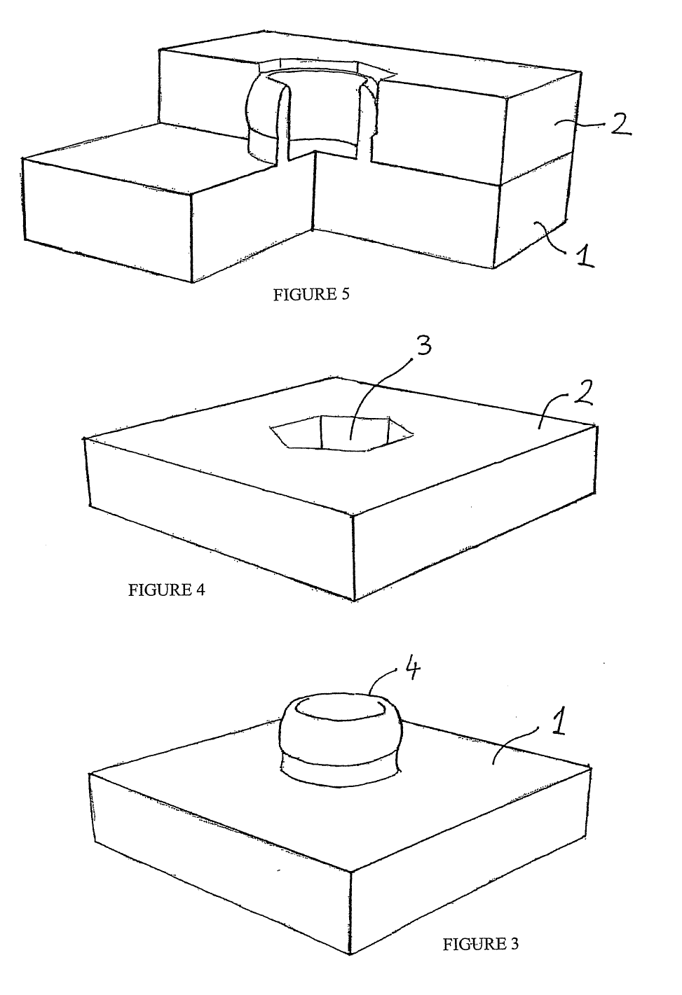

FIG. 3: a three-dimensional elevation view of the construction element having the first snap-fit element,

FIG. 4: a three-dimensional elevation view of the base element having an aperture,

FIG. 5: a three-dimensional opened-up elevation view of the snap-fit connection in which the construction element is inserted into the base element.

FIG. 1a-d shows the cross-section, side view, plan view and underneath view of the construction element 1 according to the invention having a first snap-fit element 7, which is mounted in the form of a peg integrally on the (partly) shown construction element 1. The peg is located as is shown in the Figure on the upper face of the construction element 1 and is formed with rotational symmetry with a peg wall 8, which is formed with a convex bulge in the upper region of the peg 4, i.e. on the side remote from the construction element 1, so that a bulge-like projection is produced which forms the first snap-fit element 7. Between this bulge-like projection and the construction element 1 is an undercut 9, into which the web-like or shoulder-like projection shown in FIG. 2 subsequently comes to rest.

Advantageously, the peg 4 has a cavity 10, which assists yielding of the peg wall 8 when the peg is being inserted into the aperture 3 shown in FIG. 2. To this end, the peg wall 8 consists of a flexible, in particular plastics material, in order to permit corresponding yielding upon insertion. As is shown in FIG. 1a, the bulge-like projection has a first diameter P1, which is larger than the undercut diameter P3, which is in turn larger than the cavity diameter P2 measured on the inner wall of the peg 4.

FIG. 2 shows the cross-section, elevation view, plan view and underneath view of the base element 2 with the aperture 3 and second snap-fit element 5. The second snap-fit element 5 consists of a projection which is in this case shoulder-like and which extends from the upper face (as is shown in FIG. 2b, the upper face is positioned turned down) into the interior of the aperture 3 as far as a shoulder depth P2. The aperture 3 has an aperture depth T1, which is preferably as large as the structural height of the base element 2, i.e. it is a through aperture. The wall distance B1 of the mutually opposing walls of the aperture 3 is in this case larger than the snap-fit distance B2 which is measured between a web-like or shoulder-like projection and the opposing wall or between two mutually opposing web-like or shoulder-like projections. The wall distance B1 is preferably equal to or larger than the first diameter P1 of the bulge-like projection of the first snap-fit element, whilst the snap-fit distance B2 is equal to or larger than the undercut diameter P3, but smaller than the first diameter P1. Thus the bulge-like projection of the peg 4 can slide during insertion into the aperture 3 over the projection 5 and relax again upon reaching the shoulder depth T2. The shoulder depth T2 is in this case preferably equal to or smaller than the undercut height H2, whilst the peg height H1 is smaller than or equal to the aperture depth T1.

As is shown in FIG. 2d, the aperture 3 consists of six walls, the two walls horizontally opposing one another having the shoulder-like projection of the second snap-fit element.

FIGS. 3 to 5 show three-dimensional diagrams of the construction element 1, with pegs 4 of the base element 2, the aperture 3 and the snap-fit connection, which shows the construction element and the base element in the assembled diagram, in which the snap-fitting location of the bulge-like projection is made visible.

It is also conceivable to equip all the walls 6 of the aperture 3 with web-like or shoulder-like projections, but it has been founding the present invention that on the one hand due to the hexagonal configuration of the aperture 3 slight rotation of the elements relative to one another is possible without the connection coming undone too easily. At the same time, detachment of the construction element from the base element is possible without excessive use of force, so that by the combination of a rotationally symmetrical peg 4 with a hexagonal aperture 3, a particularly advantageous snap-fit connection is obtained, which fulfils the requirements set, such as being easy to rotate, forming a reliable connection, being easy to detach and simple to manufacture.

1. Snap-fit connection for construction elements having a construction element, which is connectable to a base element by bringing a first snap-fit element (7) of the construction element into engagement with a second snap-fit element (5) of the base element, the second snap-fit element (5) being located inside an aperture (3) in the base element (2), characterised in that the first snap-fit element (7) has a bulge-like projection with a bulge diameter (P1) and the second snap-fit element (5) has a web-like or shoulder-like projection on at least one wall (6) of the aperture (3).

2. Snap-fit connection according to claim 1, characterised in that the snap-fit distance (B2) between the at least one web-like or shoulder-like projection and the opposing wall (6) inside the aperture (3) is smaller than or equal to the bulge diameter (P1).

3. Snap-fit connection according to claim 1 or 2, characterised in that the second snap-fit element (5) has at least two web-like or shoulder-like projections respectively on one wall (6) of the aperture (3).

4. Snap-fit connection according to claim 3, characterised in that the at least two web-like or shoulder-like projections are located on mutually opposing walls (6) of the aperture (3) and the snap-fit distance (B2) between the at least two opposing web-like or shoulder-like projections is smaller than or equal to the bulge diameter (P1).

5. Snap-fit connection according to one of the preceding claims, characterised in that the web-like or shoulder-like projection inside the aperture (3) extends over a shoulder depth (T2) which is smaller than the aperture depth (T1) of the aperture (3).

6. Snap-fit connection according to one of the preceding claims, characterised in that the web-like or shoulder-like projection is located on the side of the aperture (3) associated with the construction element (1) to be inserted.

7. Snap-fit connection according to one of the preceding claims, characterised in that the aperture (3) has six walls (6), the web-like or shoulder-like projections being located on two opposing walls (6).

8. Snap-fit connection according to one of the preceding claims, characterised in that the bulge-like projection of the first snap-fit element (7) extends in a dome shape along a peg (4) which is fixed to the construction element (1).

9. Snap-fit connection according to one of the preceding claims, characterised in that the peg (4) and the construction element (1) are manufactured integrally, in particular from a flexible plastics material.

10. Snap-fit connection according to one of the preceding claims, characterised in that the peg (4) is formed with rotational symmetry with a cavity (10) so that upon locating of the peg (4) in the second snap-fit element (5) the peg wall (8) is displaced inwards in the direction of the cavity (10).

11. Snap-fit connection according to one of the preceding claims, characterised in that on the exterior of the peg wall (8) between the bulge-like projection of the first snap-fit element (7) and the body of the construction element (1) an undercut (9) is formed, which receives the web-like or shoulder-like projection of the second snap-fit element (5) after locating thereof.

12. Construction element (1) having a peg (4) for a snap-fit connection according to one of the preceding claims, characterised in that the peg (4) has a first snap-fit element (7) with a bulge-like projection having a bulge diameter (P1) and an undercut (9) on the exterior of the peg wall (8) between the bulge-like projection and the body of the construction element (1).

13. Base element (2) having an aperture (3) for a snap-fit connection according to one of the preceding claims, characterised in that the aperture (3) has a second snap-fit element (5) with a web-like or shoulder-like projection on at least one, in particular on two opposing walls (6) of the aperture (3).

14. Construction system having a base element (2) according to claim 13 and a construction element (2) according to claim 12, characterised in that the snap-fit distance (B2) between the web-like or shoulder-like projection and the opposing wall (6) inside the aperture (3) or between the opposing web-like or shoulder-like projections is smaller than or equal to the bulge diameter (P1).
